(19) United States
(12) Patent Application Publication
(10) Pub. No.: US 2006/0146165 A1
(43) Pub. Date: Jul. 6, 2006

(54) Digital camera and electronic device

(75) Inventors: Tsuyoshi Hagiwara, Ome-shi (JP); Tatsuhiko Ikehata, Ome-shi (JP); Tatsuro Abe, Ome-shi (JP); Kei Tashiro, Ome-shi (JP); Toyokazu Aizawa, Sagamihara-shi (JP); Shiro Nagaoka, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/215,001

(22) Filed: Aug. 31, 2005

(30) Foreign Application Priority Data
Jan. 5, 2005 (JP) 2005-000841

(51) Int. Cl. H04N 5/222

(52) U.S. Cl. 348/333.01

(57) ABSTRACT

A digital camera in this invention includes a rotary member, display unit, and display control unit. The display unit displays a selection screen on which a predetermined number of selection candidates are aligned, and identifies and displays the predetermined selection target of the predetermined number of selection candidates. The display control unit controls the transition direction of an identification display target on the basis of the rotational direction of the rotary member, identifies and displays an immediately succeeding selection candidate of the predetermined selection candidate on the basis of the first rotational speed of the rotary member, and identifies and displays an at least second succeeding selection candidate of the predetermined selection candidate on the basis of the second rotational speed of the rotary member.

### CROSS-REFERENCE TO RELATED APPLICATIONS

This application is based upon and claims the benefit of priority from prior Japanese Patent Application No. 2005-000841, filed Jan. 5, 2005, the entire contents of which are incorporated herein by reference.

### BACKGROUND OF THE INVENTION

1. Field of the Invention

The present invention relates to an electronic device such as a video photographing device (digital camera) for photographing still and moving images.

2. Description of the Related Art

In recent years, a multi-functional digital device such as a video photographing device has prevailed. Since the digital device implements multi-functions, its operations are sometimes complicated. In order to easily perform these complex operations, in Jpn. Pat. Appln. KOKAI Publication No. 2004-80477, a proposal has been made about the operation of a cross key. The cross key is used to select items in a vertical direction in addition to a horizontal direction. Accordingly, one key called “cross key” can relatively easily select many items.

For example, in a digital camera, a list of thumbnail images such as still images or representative frames of a moving image is displayed. More specifically, on the liquid crystal display of the digital camera, a list of nine images is displayed in the form of a matrix. In order to select a desired image from the display list, the above-described cross key (four-direction key) is used. When the cross key is used to input an instruction once (pressed once), an image adjacent to the currently selected image is newly selected. When the cross key is used to repeatedly input instructions (repeatedly pressed), images are successively selected at a constant speed, and a screen is scrolled. When the cross key is continuously used to repeatedly input instructions, an image selection speed and a screen scroll speed are increased.

In the digital camera, a menu screen for various settings is also displayed. In this menu screen, for example, about six selection items are aligned and displayed. In order to select a desired selection item from this menu screen, the above-described cross key is used. When the cross key is used to input an instruction once (pressed once), a selection item adjacent to the currently selected selection item is newly selected. When the cross key is used to repeatedly input instructions (repeatedly pressed), the selection items are successively selected at a constant speed, and the screen is scrolled. When the cross key is continuously used to repeatedly input instructions, the selection speed of the selection item and the screen scroll speed are increased.

In addition to this, in the digital camera, manual focus adjustment can be attained. For example, “left” or “right” key is used to attain this adjustment. When the “left” or “right” key is used to input an instruction once (pressed once), a focus adjustment lens is moved by one step (fixed number of steps).

When the cross key is used to select the image as described above, the time until a target image is displayed becomes longer along with an increase in the number of images, thus posing a problem. Furthermore, since the scroll speed is changed in repeatedly inputting instructions, the scroll speed cannot be controlled at an optimal value required by a user. Additionally, since the scroll speed becomes too high, the target image is missed, or it takes a little long time to reach the optimal scroll speed.

The above-described problems are also posed in a case wherein the item is selected on the menu screen.

In the manual focus adjustment, a pulse count for driving the focus adjustment lens is changed in accordance with an object distance. Hence, when changing the fixed number of steps, the moving speeds with respect to the distances in a long focus and a short focus decrease.

### BRIEF SUMMARY OF THE INVENTION

According to an aspect of the present invention, there is provided a digital camera comprising a photographing unit configured to photograph a video, a recording unit configured to record the video photographed by the photographing unit, a rotary member, a display unit configured to display the video photographed by the photographing unit, display, in response to a display switching operation, a selection screen on which a predetermined number of successive selection candidates of a plurality of selection candidates are aligned, and identify and display a predetermined selection target of the predetermined number of selection candidates, and a display control unit configured to control a transition direction of an identification display target on the basis of a rotational direction of the rotary member, identify and display an immediately succeeding selection candidate or an immediately preceding selection candidate of a predetermined selection candidate on the basis of a first rotational speed of the rotary member, and identify and display an at least second succeeding selection candidate or an at least second preceding selection candidate of the predetermined selection candidate on the basis of a second rotational speed of the rotary member.

According to another aspect of the present invention, there is provided an electronic device comprising a rotary member, a display unit configured to display a selection screen on which a predetermined number of successive selection candidates of a plurality of selection candidates are aligned, and identify and display a predetermined selection target of the predetermined number of selection candidates, and a display control unit configured to control a transition direction of an identification display target on the basis of a rotational direction of the rotary member, identify and display an immediately succeeding selection candidate or an immediately preceding selection candidate of a predetermined selection candidate on the basis of a first rotational speed of the rotary member, and identify and display an at least second succeeding selection candidate or an at least second preceding selection candidate of the predetermined selection candidate on the basis of a second rotational speed of the rotary member.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing an example of a video photographing device of the present invention;

FIG. 2 is a view showing an example of a state wherein a video on a display unit in the video photographing device shown in FIG. 1 is made visible;

FIG. 3 is a view for explaining a detailed example of a jog dial and a determination button in the video photographing device shown in FIGS. 1 and 2;

FIG. 4 is a functional block diagram for explaining an example of the main function of the video photographing device shown in FIGS. 1 to 3;

FIG. 5 is a view showing an example of a selection screen on which a list of thumbnail images such as still images or representative frames of a moving image which are captured by the video photographing device is displayed;

FIG. 6 is a flowchart showing an example of a selection operation performed on the selection screen in FIG. 5 on which the list of thumbnail images is displayed;

FIG. 7 is a table showing an example of the relationship between a pulse count per unit time and a rotational amount in the selection operation shown in FIG. 6;

FIG. 8 is a view showing an example of the menu screen of the video photographing device;

FIG. 9 is a flowchart showing an example of the selection operation performed on the menu screen shown in FIG. 8;

FIG. 10 is a table showing an example of the relationship between a pulse count per unit time and a rotational amount in the selection operation shown in FIG. 9;

FIG. 11 is a graph showing an example of the relationship between the number of focus steps and an object distance;

FIG. 12 is a flowchart showing an example of focus distance control corresponding to the operation of a jog dial;

FIG. 13 is a table showing an example of the relationship between the object distance and the defined number of steps, the relationship representing an increase in the defined number of steps along with a decrease in the object distance; and

FIG. 14 is a table showing an example of the relationship between the pulse count per unit time and the rotational amount in the focus distance control shown in FIG. 12.

### DETAILED DESCRIPTION OF THE INVENTION

An embodiment of the present invention will be described below with reference to the accompanying drawing.

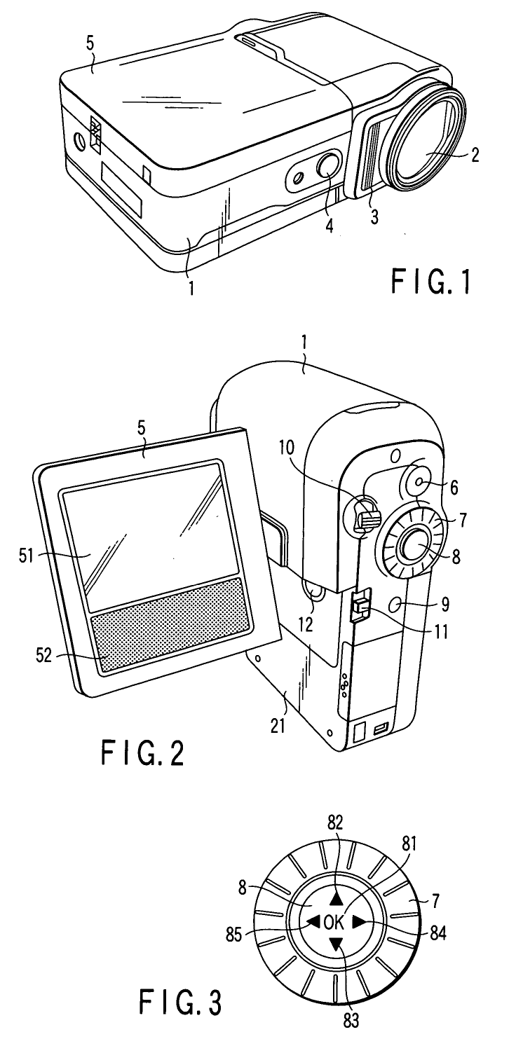

FIGS. 1 and 2 are views showing the example of a video photographing device (digital camera) of the present invention. FIG. 1 is a view showing the state wherein a display unit is housed in a housing unit arranged in the main body of the video photographing device. FIG. 2 is a view showing the state wherein a video on the display unit is made visible.

As shown in FIGS. 1 and 2, the video photographing device has a main body 1. The main body 1 includes a lens 2, flush 3, shutter button 4, display unit 5, moving image recording button 6, jog dial (rotary member) 7, direction key 8, menu button 9, zoom bar 10, mode lever 11, power button 12, and the like.

The main body 1 also includes a housing portion 21 in which the display unit 5 can be housed. The display unit 5 is movable so that the display unit 5 can be opened from the housing portion 21, and the angle of a display surface can be arbitrarily adjusted. The display unit 5 includes an LCD (Liquid Crystal Display) 51 and loudspeaker 52.

FIG. 3 is a view for explaining the jog dial and the determination button in detail.

As shown in FIG. 3, the jog dial 7 has a ring shape. The jog dial 7 can be rotated clockwise and counterclockwise. Note that the shape of the jog dial 7 is not limited to the ring shape. The jog dial 7 may have a polygonal ring shape such that a finger can easily catch the jog dial.

The circular determination button 8 is arranged in the jog dial 7. The direction button 8 has a determination key 81 at the center position, an UP key 82 at the upper position, a DOWN key 83 at the lower position, a RIGHT key 84 at the right position, and a LEFT key 85 at the left position.

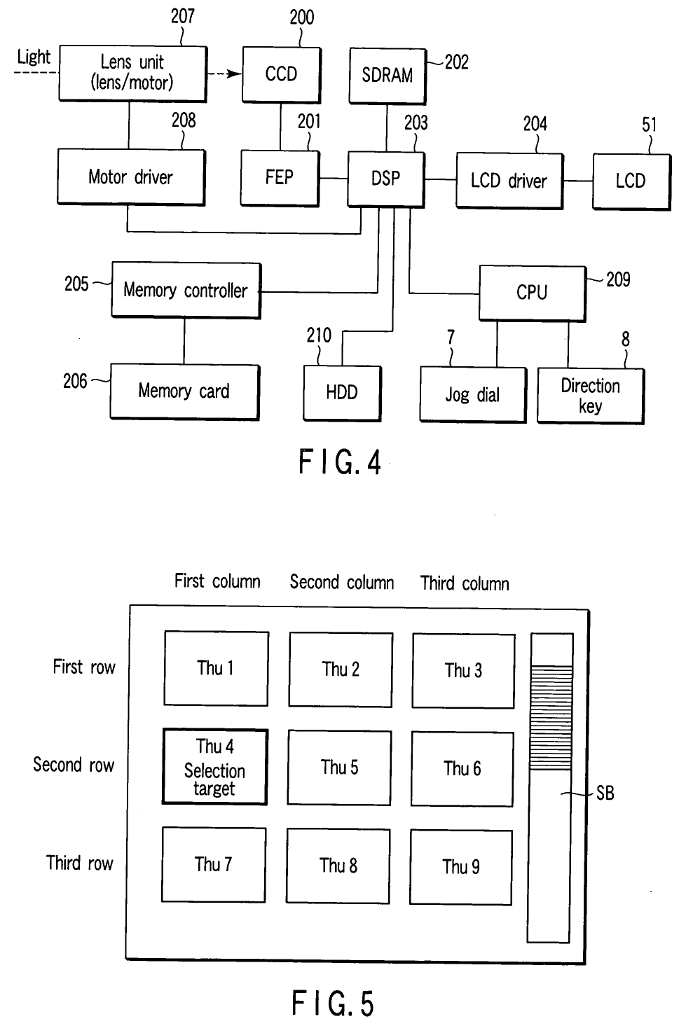

FIG. 4 is a block diagram showing the schematic arrangement of the video photographing device explained with reference to FIGS. 1 to 3.

The video photographing device includes a CCD 200 serving as a photoelectric conversion unit, a front end processor (FEP) 201, an SDRAM 202, a digital signal processor (DSP) 203, an LCD driver 204, a memory controller 205, a memory card 206, a lens unit 207 serving as a focus distance control unit, a motor driver 208 serving as the focus distance control unit, a sub-CPU 209, an HDD 210, and the like. The lens unit 207 includes a focus adjustment lens and a focus adjustment motor for moving this focus adjustment lens.

Upon operation of the shutter button 4, the CCD 200 converts light (still image) obtained via the lens 2 and the focus adjustment lens included in the lens unit 207 into an electrical signal. Alternatively, upon operation of the moving image recording button 6, the CCD 200 converts light (moving image) obtained via the lens 2 and the focal adjustment lens included in the lens unit 207 into the electrical signal. The FEP 201 converts the electrical signal output from the CCD 200 into the digital signal. The DSP 203 supplies the digital signal of the still or moving image to the LCD driver 204. The DSP 203 encodes the still image digital signal into a JPEG image signal. The DSP 203 also encodes the moving image digital signal into an MPEG image signal. Note that the DSP 203 uses the SDRAM 202 as a signal processing external memory. The HDD 210 stores the encoded image signal. The detachable memory card 206 also stores the encoded image signal via the memory card controller 205. The LCD driver 204 controls to drive the LCD 51 on the basis of the digital signal of the still or moving image, and displays the image on the LCD 51. When playing back the recorded image, the DSP 203 decodes the encoded image signal output from the HDD 210 or the memory card 206. The decoded image signal is supplied to the LCD driver 204.

A user input operation is accepted by the jog dial 7 and direction key 8. The input operation accepted by the jog dial 7 or the direction key 8 is detected by the sub-CPU 209. The sub-CPU 209 transmits the signal corresponding to the input operation to the DSP 203. For example, upon rotation of the jog dial 7, the jog dial 7 outputs the pulse in accordance with a predetermined rotational angle. For example, when the jog dial 7 is rotated n°, the jog dial 7 outputs one pulse. At the same time, the jog dial 7 also outputs a signal indicating a rotational direction. The sub-CPU 209 detects the rotational direction of the jog dial 7 on the basis of the signal indicating the rotational direction. The sub-CPU 209 also checks a pulse count, and detects the rotational amount of the jog dial 7. Additionally, the sub-CPU 209 detects the rotational angle (rotational speed) per unit time from the pulse count per unit time.

With reference to FIGS. 5 to 14, various operations of the jog dial 7 will be explained.

The thumbnail image selection operation of the jog dial 7 will be described below.

FIG. 5 is a view showing an example of a selection screen on which the list of thumbnail images such as still images or representative frames of a moving image captured by the video photographing device is displayed. For example, the LCD 51 displays the selection screen on which successive nine of the thumbnail images (selection candidates) stored in the HDD 210 are arranged in 3 rows×3 columns (matrix). On this screen, thumbnail images Thu1 to Thu9 are successively arranged, and the thumbnail image Thu4 serving as a selection target is identified and displayed. On the right end of the selection screen, a scroll bar SB is displayed.

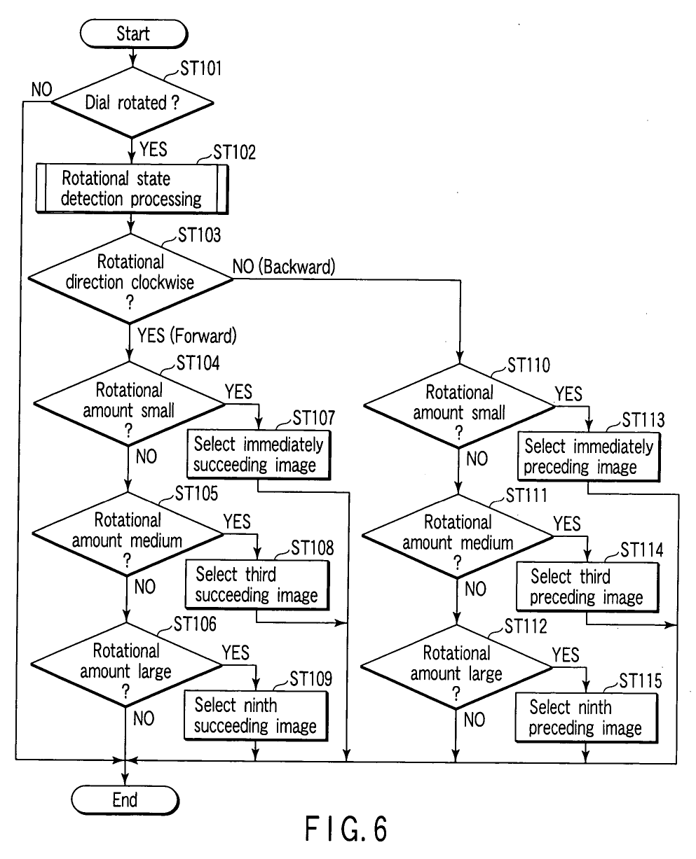

FIG. 6 is a flowchart showing an example of the selection operation performed on the selection screen in FIG. 5 on which the list of thumbnail images is displayed.

Upon rotation of the jog dial 7 (ST101, YES), the sub-CPU 209 detects the rotational direction, rotational amount, and rotational speed (ST102).

In a case wherein clockwise rotation (forward rotation) is detected (ST103, YES), and the rotational amount per unit time is small (the rotational speed is low) (ST104, YES), the sub-CPU 209, DSP 203, and LCD driver 204 perform display control to select an immediately succeeding thumbnail image (ST107). That is, the thumbnail image (e.g., the thumbnail image Thu5) immediately succeeding the currently selected (currently identified and displayed) thumbnail image (e.g., the thumbnail image Thu4) is selected (identified and displayed). Similarly, in a case wherein one more succeeding thumbnail image (e.g., the thumbnail image Thu6) is selected, and one more succeeding thumbnail image (e.g., the thumbnail image Thu7) is then selected, at this selection timing, the sub-CPU 209, DSP 203, and LCD driver 204 perform display control to transit the nine thumbnail images (e.g., the thumbnail images Thu1 to Thu9) aligned in the selection screen. That is, on the basis of rotation of the jog dial 7, the nine thumbnail images (e.g., thumbnail images Thu1 to Thu9) aligned in the selection screen are transited when a thumbnail image (e.g., the thumbnail image Thu7) belonging to a row (third row) different from that (second row) to which the currently selected (currently identified and displayed) thumbnail image (e.g., the thumbnail image Thu6) belongs is selected. By this transition, for example, the thumbnail images Thu4 to Thu6 are aligned on the first row, the thumbnail images Thu7 to Thu9 are aligned on the second row, and thumbnail images Thu10 to Thu12 (not shown) are aligned on the third row.

In a case wherein clockwise rotation (forward rotation) is detected (ST103, YES), and the rotational amount per unit time is medium (the rotational speed is slightly high) (ST105, YES), the sub-CPU 209, DSP 203, and LCD driver 204 perform display control to select a third succeeding thumbnail image (ST108). That is, the thumbnail image (e.g., the thumbnail image Thu7) third succeeding the currently selected (currently identified and displayed) thumbnail image (e.g., the thumbnail image Thu4) is selected (identified and displayed). As described above, when the rotational speed of the jog dial 7 is slightly high, a thumbnail image (e.g., the thumbnail image Thu7) belonging to the row (third row) different from that (second row) to which the currently selected (currently identified and displayed) thumbnail image (e.g., the thumbnail image Thu4) belongs, and belonging to a column (first column) which is the same as that (first column) to which the currently selected (currently identified and displayed) thumbnail image (e.g., the thumbnail image Thu4) belongs is selected (identified and displayed). Furthermore, at this selection timing, the sub-CPU 209, DSP 203, and LCD driver 204 perform display control to transit the nine thumbnail images (e.g., the thumbnail images Thu1 to Thu9) aligned in the selection screen. That is, on the basis of rotation of the jog dial 7, the nine thumbnail images (e.g., thumbnail images Thu1 to Thu9) aligned in the selection screen are transited when the thumbnail image (e.g., the thumbnail image Thu7) belonging to the row (third row) different from that (second row) to which the currently selected (currently identified and displayed) thumbnail image (e.g., the thumbnail image Thu4) belongs is selected. By this transition, for example, the thumbnail images Thu4 to Thu6 are aligned on the first row, the thumbnail images Thu7 to Thu9 are aligned on the second row, and the thumbnail images Thu10 to Thu12 (not shown) are aligned on the third row.

In a case wherein clockwise rotation (forward rotation) is detected (ST103, YES), and the rotational amount per unit time is large (the rotational speed is very high) (ST106, YES), the sub-CPU 209, DSP 203, and LCD driver 204 perform display control to select a ninth (one screen) succeeding thumbnail image (ST108). That is, the thumbnail image (e.g., the thumbnail image Thu13) (not shown) ninth succeeding the currently selected (currently identified and displayed) thumbnail image (e.g., the thumbnail image Thu4) is selected (identified and displayed). As described above, when the rotational speed of the jog dial 7 is very high, a thumbnail image (e.g., the thumbnail image Thu13) (not shown) belonging to a row (fifth row) different from that (second row) to which the currently selected (currently identified and displayed) thumbnail image (e.g., the thumbnail image Thu4) belongs, and belonging to the column (first column) which is the same as that (first column) to which the currently selected (currently identified and displayed) thumbnail image (e.g., the thumbnail image Thu4) belongs is selected (identified and displayed). Furthermore, at this selection timing, the sub-CPU 209, DSP 203, and LCD driver 204 perform display control to transit the nine thumbnail images (e.g., the thumbnail images Thu1 to Thu9) aligned in the selection screen. That is, on the basis of rotation of the jog dial 7, all the nine thumbnail images (e.g., thumbnail images Thu1 to Thu9) aligned in the selection screen are transited when a thumbnail image (e.g., the thumbnail image Thu13) (not shown) belonging to the row (fifth row) different from that (second row) to which the currently selected (currently identified and displayed) thumbnail image (e.g., the thumbnail image Thu4) belongs is selected. By this transition, for example, the thumbnail images Thu10 to Thu12 (not shown) are aligned on the first row, the thumbnail images Thu13 to Thu15 (not shown) are aligned on the second row, and thumbnail images Thu16 to Thu18 (not shown) are aligned on the third row.

As described above, when the rotational speed of the jog dial 7 is low, the screen transition speed (scroll speed) also becomes low. When the rotational speed of the jog dial 7 is slightly high, the screen transition speed (scroll speed) also becomes slightly high. When the rotational speed of the jog dial 7 is very high, the screen transition speed (scroll speed) also becomes very high.

In a case wherein counterclockwise rotation (backward rotation) is detected (ST103, NO), and the rotational amount per unit time is small (the rotational speed is low) (ST110, YES), the sub-CPU 209, DSP 203, and LCD driver 204 perform display control to select an immediately preceding thumbnail image (ST113). That is, the thumbnail image (e.g., the thumbnail image Thu3) immediately preceding the currently selected (currently identified and displayed) thumbnail image (e.g., the thumbnail image Thu4) is selected (identified and displayed). At this selection timing, the sub-CPU 209, DSP 203, and LCD driver 204 perform display control to transit the nine thumbnail images (e.g., the thumbnail images Thu1 to Thu9) aligned in the selection screen.

In a case wherein counterclockwise rotation (backward rotation) is detected (ST103, NO), and the rotational amount per unit time is medium (the rotational speed is slightly high) (ST111, YES), the sub-CPU 209, DSP 203, and LCD driver 204 perform display control to select a third preceding thumbnail image (ST114). At this selection timing, the sub-CPU 209, DSP 203, and LCD driver 204 perform display control to transit the nine thumbnail images (e.g., the thumbnail images Thu1 to Thu9) aligned in the selection screen.

In a case wherein counterclockwise rotation (backward rotation) is detected (ST103, NO), and the rotational amount per unit time is large (the rotational speed is very high) (ST112, YES), the sub-CPU 209, DSP 203, and LCD driver 204 perform display control to select a ninth (one screen) preceding thumbnail image (ST115). At this selection timing, the sub-CPU 209, DSP 203, and LCD driver 204 perform display control to transit all the nine thumbnail images (e.g., the thumbnail images Thu1 to Thu9) aligned in the selection screen.

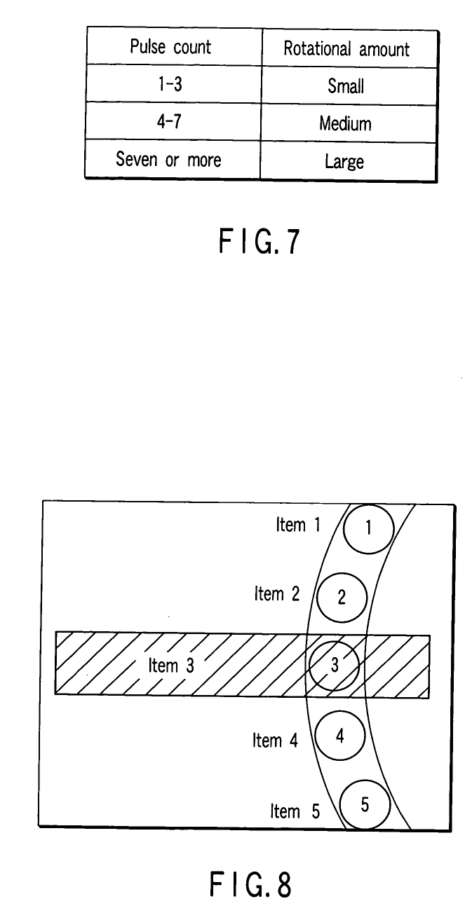

FIG. 7 is a table showing the relationship between the pulse count per unit time and the rotational amount. The sub-CPU 209 holds information indicating the relationship between the pulse count per unit time and the rotational amount. On the basis of the information, the sub-CPU 209 determines whether the rotational amount per unit time is small (the rotational speed is low), medium (the rotational speed is slightly high), or large (the rotational speed is very high).

The sub-CPU 209, DSP 203, and LCD driver 204 perform display control not to identify and display a specific thumbnail image during rotation of the jog dial 7, when the rotational speed of the jog dial 7 is very high. Hence, the visibility can be increased.

As described above, in large movement from a predetermined thumbnail image to a target thumbnail image, the rotational speed of the jog dial 7 increases. To the contrary, the rotational speed of the jog dial 7 decreases near the target thumbnail image. Hence, the thumbnail image can be seamlessly selected without stopping rotation of the jog dial 7, thus improving user's convenience.

Next, an item selection operation of the jog dial 7 will be described.

FIG. 8 is a view showing an example of the menu screen of the video photographing device. For example, on the menu screen of the LCD 51, the plurality of selection candidates (items 1 to 5) are displayed as icons and sequentially aligned on an arc. On the menu screen, only one (e.g., the item 3) of the selection candidates is identified and displayed by a cursor or the like. The jog dial 7 is arranged visually concentrically with the arc on the menu screen.

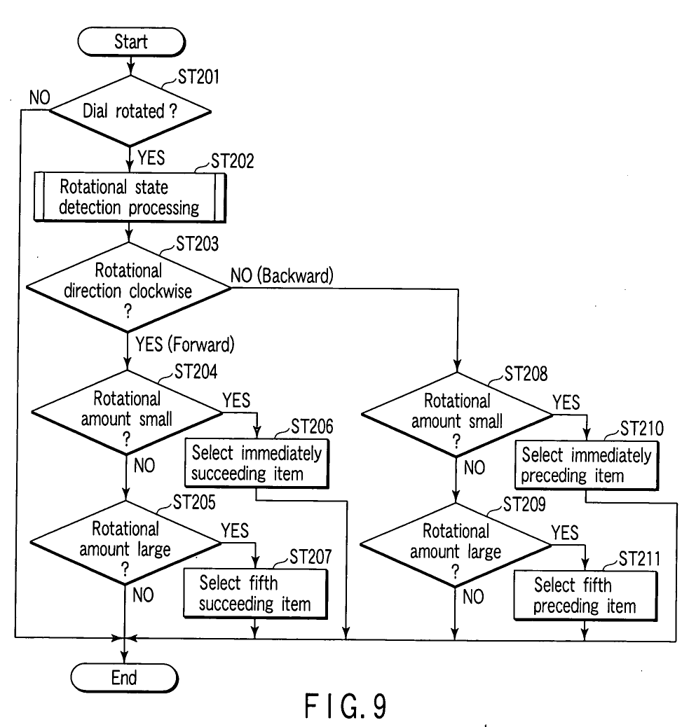

FIG. 9 is a flowchart showing an example of the selection operation performed on the menu screen shown in FIG. 8. Upon rotation of the jog dial 7 (ST201, YES), the sub-CPU 209 detects the rotational direction, rotational amount, and rotational speed (ST202).

In a case wherein clockwise rotation (forward rotation) is detected (ST203, YES), and the rotational amount per unit time is small (the rotational speed is low) (ST204, YES), the sub-CPU 209, DSP 203, and LCD driver 204 perform display control to select an immediately succeeding item (ST206). That is, the item (e.g., the item 4) immediately succeeding the currently selected (currently identified and displayed) item (e.g., the item 3) is selected (identified and displayed). At this selection timing, the sub-CPU 209, DSP 203, and LCD driver 204 perform display control to transit the five items (e.g., the items 1 to 5) aligned in the selection screen. By this transition, for example, the items 2 to 6 (not shown) are aligned.

In a case wherein clockwise rotation (forward rotation) is detected (ST203, YES), and the rotational amount per unit time is large (the rotational speed is high) (ST205, YES), the sub-CPU 209, DSP 203, and LCD driver 204 perform display control to select a fifth (one screen) succeeding item (ST207). That is, the item (e.g., the item 8 (not shown)) fifth succeeding the currently selected (currently identified and displayed) item (e.g., the item 3) is selected (identified and displayed). At this selection timing, the sub-CPU 209, DSP 203, and LCD driver 204 perform display control to transit all the five items (e.g., the items 1 to 5) aligned in the selection screen. By this transition, for example, the items 6 (not shown) to 10 (not shown) are aligned.

As described above, when the rotational speed of the jog dial 7 is low, the screen transition speed (scroll speed) becomes low. When the rotational speed of the jog dial 7 is high, the screen transition speed (scroll speed) becomes high.

In a case wherein counterclockwise rotation (backward rotation) is detected (ST203, NO), and the rotational amount per unit time is small (the rotational speed is low) (ST208, YES), the sub-CPU 209, DSP 203, and LCD driver 204 perform display control to select an immediately preceding item (ST210). That is, the item (e.g., the item 2) immediately preceding the currently selected (currently identified and displayed) item (e.g., the item 3) is selected (identified and displayed). At this selection timing, the sub-CPU 209, DSP 203, and LCD driver 204 perform display control to transit the five items (e.g., the items 1 to 5) aligned in the selection screen.

In a case wherein counterclockwise rotation (backward rotation) is detected (ST203, YES), and the rotational amount per unit time is large (the rotational speed is high) (ST209, YES), the sub-CPU 209, DSP 203, and LCD driver 204 perform display control to select a fifth (one screen) preceding item (ST211). At this selection timing, the sub-CPU 209, DSP 203, and LCD driver 204 perform display control to transit all the five items (e.g., the items 1 to 5) aligned in the selection screen.

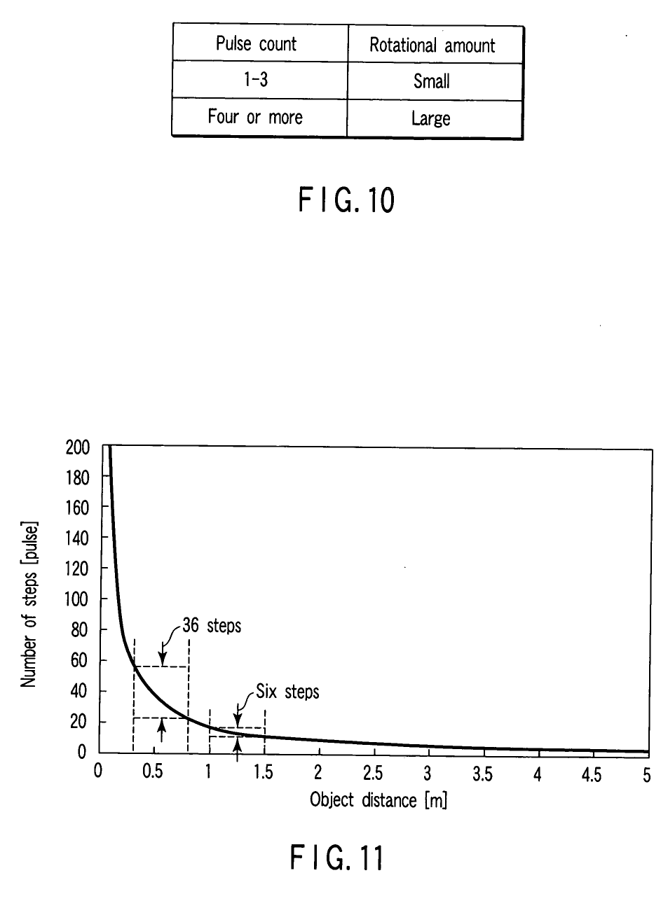

FIG. 10 is a table showing the relationship between the pulse count per unit time and the rotational amount. The sub-CPU 209 holds information indicating the relationship between the pulse count per unit time and the rotational amount. On the basis of the information, the sub-CPU 209 determines whether the rotational amount per unit time is small (the rotational speed is low) or large (the rotational speed is high).

The sub-CPU 209, DSP 203, and LCD driver 204 perform display control not to identify and display a specific item during rotation of the jog dial 7 when the rotational speed of the jog dial 7 is high. Hence, the visibility of the menu screen can be increased.

As described above, in large transition from a predetermined item to a target item, the rotational speed of the jog dial 7 increases. To the contrary, the rotational speed of the jog dial 7 decreases near the target item. Hence, the item can be seamlessly selected without stopping rotation of the jog dial 7, thus improving user's convenience.

Next, a manual focus operation of the jog dial 7 will be described.

When a general single-lens reflex camera lens is used, upon rotation of a ring called a focus ring, a focus lens can be manually moved to a focus distance in accordance with user's intention. In this video photographing device, upon rotation of the jog dial 7, the motor of the lens unit 207 is driven to move the focus adjustment lens of the lens unit 207. As a result, the focus distance (the distance between the focus adjustment lens and the CCD 200) is changed.

In the conventional digital camera or the like, when the left or right position of the cross key is pressed, the motor is driven, and the focus distance changes. That is, when the left or right position of the cross key is pressed, the focus distance changes. For example, when the left or right position of the cross key is pressed once, the motor is driven by one step. Similarly, when the left or right position of the cross key is pressed twice, the motor is driven by two steps. Alternatively, when the left or right position of the cross key is pressed for a period of time n, the motor is driven by n steps. When the left or right position of the cross key is pressed for a period of time 2n, the motor is driven by 2n steps.

However, the relationship between the number of focus steps and the object distance is as follows shown in FIG. 11. For example, while an object distance of 50 cm (=1 m-1.5 m) corresponds to the six focus steps, an object distance of 50 cm (=0.35 m-0.85 m) corresponds to the 36 focus steps. That is, the number of focus steps corresponding to an object distance of 50 cm in a minimum object distance range is about 100× of that in an infinity range. Hence, when the lens is moved by the same number of steps in the infinity range and the minimum object distance range, the focus distance change is very large in the infinity range, and the focus distance change is very small in the minimum object distance range. Therefore, as in the conventional case, since the lens position moves in proportion to the number (or the period of time) of depressions for the left or right position of the cross key, user's operability is decreased (the focus adjustment becomes difficult).

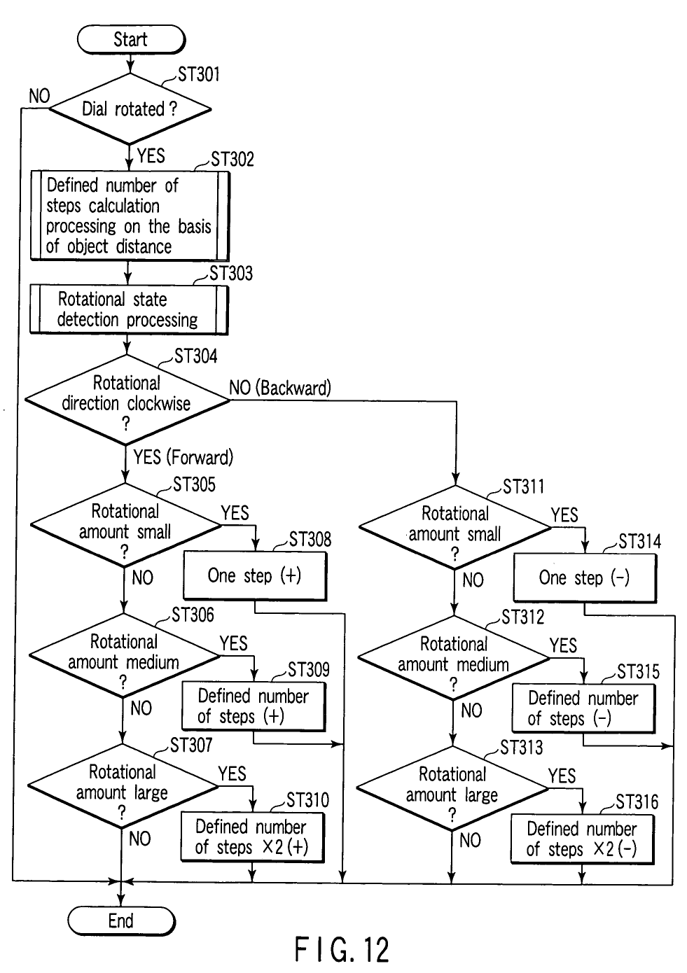

In the video photographing device of this invention, as shown in FIG. 12, since the focus distance is adjusted with respect to the operation of the jog dial 7, the operability is largely improved (the focus adjustment becomes easy). FIG. 12 is a flowchart showing an example of focus distance control with respect to the operation of a jog dial 7.

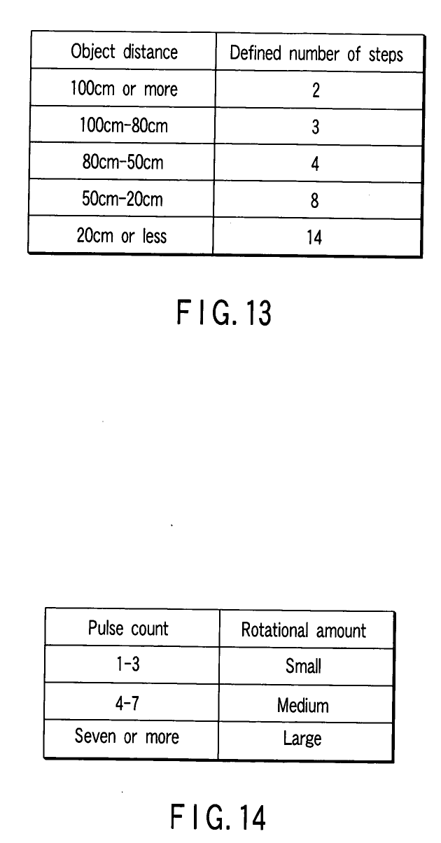

Upon rotation of the jog dial 7 (ST301, YES), for example, the DSP detects the object distance on the basis of the electrical signal from the CCD 200, and determines the defined number of steps on the basis of the detected object distance (ST302). For example, the defined number of steps is determined on the basis of the relationship between the object distance and the defined number of steps, which relationship represents an increase in the defined number of steps along with a decrease in the object distance as shown in FIG. 13. Furthermore, the sub-CPU 209 detects the rotational direction, rotational amount, and rotational speed of the jog dial 7 (ST303).

In a case wherein clockwise rotation is detected (ST304, YES), and the rotational amount per unit time is small (the rotational speed is low) (ST305, YES), the DSP 203 sets one step (+) (ST305). The motor driver 208 drives the motor of the lens unit 207 by one step (+) on the basis of the set one step (+) Upon driving this motor by one step (+), the focus adjustment lens is moved by one step (+).

In a case wherein clockwise rotation is detected (ST304, YES), and the rotational amount per unit time is medium (the rotational speed is slightly high) (ST306, YES), the DSP 203 sets the defined number of steps (+) (ST309). The motor driver 208 drives the motor of the lens unit 207 by the defined number of steps (+) on the basis of the set defined number of steps (+). Upon driving this motor by the defined number of steps (+), the focus adjustment lens is moved by the defined number of steps (+).

In a case wherein clockwise rotation is detected (ST304, YES), and the rotational amount per unit time is large (the rotational speed is very high) (ST307, YES), the DSP 203 sets a predetermined multiple (e.g., twice) of the defined number of steps (+) (ST309). The motor driver 208 drives the motor of the lens unit 207 by the predetermined multiple of the defined number of steps (+) on the basis of the set predetermined multiple of the defined number of steps (+). Upon driving this motor by the predetermined multiple of the defined number of steps (+), the focus adjustment lens is moved by the predetermined multiple of the defined number of steps (+).

In a case wherein counterclockwise rotation is detected (ST304, NO), and the rotational amount per unit time is small (the rotational speed is low) (ST311, YES), the DSP 203 sets one step (−) (ST314). The motor driver 208 drives the motor of the lens unit 207 by one step (−) on the basis of the set one step (−). Upon driving this motor by one step (−), the focus adjustment lens is moved by one step (−).

In a case wherein counterclockwise rotation is detected (ST304, NO), and the rotational amount per unit time is medium (the rotational speed is slightly high) (ST312, YES), the DSP 203 sets one step (−) (ST315). The motor driver 208 drives the motor of the lens unit 207 by the defined number of steps (−) on the basis of the set defined number of steps (−). Upon driving this motor by the defined number of steps (−), the focus adjustment lens is moved by the defined number of steps (−).

In a case wherein counterclockwise rotation is detected (ST304, NO), and the rotational amount per unit time is large (the rotational speed is very high) (ST313, YES), the DSP 203 sets a predetermined multiple (e.g., twice) of the defined number of steps (−) (ST316). The motor driver 208 drives the motor of the lens unit 207 by the predetermined multiple of the defined number of steps (−) on the basis of the set predetermined multiple of the defined number of steps (−). Upon driving this motor by the predetermined multiple of the defined number of steps (−), the focus adjustment lens is moved by the predetermined multiple of the defined number of steps (−).

FIG. 14 is a table showing the relationship between the pulse count per unit time and the rotational amount. The sub-CPU 209 holds information indicating the relationship between the pulse count per unit time and the rotational amount. On the basis of the information, the sub-CPU 209 determines whether the rotational amount per unit time is small (the rotational speed is low), medium (the rotational speed is slightly high), or large (the rotational speed is very high).

As described above, in this video photographing device, on the basis of the object distance and the rotational speed of the jog dial 7, the changeable range of the focus distance between the focus adjustment lens and the CCD 200 is controlled. That is, when the object distance is small and the rotational speed is high, the changeable range of the focus distance becomes large. When the object distance is large, the changeable range of the focus distance becomes small even if the rotational speed is high.

For example, when the object distance is 100 cm or more and the rotational speed of the jog dial 7 is slightly high, the changeable range of the focus distance is controlled by two steps. When the object distance is 20 cm or less and the rotational speed of the jog dial 7 is slightly high, the changeable range of the focus distance is controlled by 14 steps. Additionally, when the object distance is 80 cm-50 cm and the rotational speed of the jog dial 7 is low, the changeable range of the focus distance is controlled by one step. When the object distance is 80 cm-50 cm and the rotational speed of the jog dial 7 is slightly high, the changeable range of the focus distance is controlled by four steps. When the object distance is 80 cm-50 cm and the rotational speed of the jog dial 7 is very high, the changeable range of the focus distance is controlled by eight steps.

As described above, when the rotational amount per unit time is small (the rotational speed is low), focus operation must be executed with high precision. Hence, regardless of the object distance, the lens is controlled to be moved by one step. When the rotational amount per unit time is medium (the rotational speed is slightly high), the focus adjustment lens is moved on the basis of the defined number of steps set in accordance with the object distance. When the rotational amount per unit time is large (the rotational speed is high), the focus adjustment lens is moved on the basis of the twice of the defined number of steps set in accordance with the object distance. Hence, the focus distance selection can be quickly executed. In addition to this, the focus distance can be seamlessly selected with high precision only by decreasing the rotational speed. As described above, the focus distance can be adjusted with good operability, thus improving user's convenience.

The functional effects of the present invention will be summarized below.

In the present invention, on the basis of the rotational speed of the jog dial 7, various switching speeds can be implemented. Hence, the operability is improved, thus improving user's convenience.

1. Other than the direction key, the rotary switch such as the jog dial 7 can be used to perform display at the scroll speed corresponding to the rotational speed. Hence, the scroll speed in accordance with user's intention can easily be obtained.

2. When the user finds the target image during rotation of the jog dial 7, the target image can be displayed by the cursor or the like only by stopping rotation of the jog dial 7. Hence, when the thumbnail image is selected from the thumbnail list display screen, or when the item is selected from the menu screen, the time until the target thumbnail image or item is displayed can be reduced.

3. In the manual focus adjustment, the number of operation steps can be changed in accordance with the object distance. Hence, the focus distance adjustment can be performed in accordance with the object distance. When the rotational speed is high, the number of lens driving steps is largely increased. When the rotational speed is low, the number of lens driving steps is largely decreased. When the rotation of the jog dial 7 is stopped, the lens is immediately stopped. With this operation, the manual focus distance adjustment can be speedily performed, and the focus distance adjustment can be performed in accordance with the user's intention. As a result, user's convenience can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital camera comprising:
a photographing unit configured to photograph a video;
a recording unit configured to record the video photographed by the photographing unit;
a rotary member;
a display unit configured to display the video photographed by the photographing unit, display, in response to a display switching operation, a selection screen on which a predetermined number of successive selection candidates of a plurality of selection candidates are aligned, and identify and display a predetermined selection target of the predetermined number of selection candidates; and
a display control unit configured to control a transition direction of an identification display target on the basis of a rotational direction of the rotary member, identify and display an immediately succeeding selection candidate or an immediately preceding selection candidate of a predetermined selection candidate on the basis of a first rotational speed of the rotary member, and identify and display an at least second succeeding selection candidate or an at least second preceding selection candidate of the predetermined selection candidate on the basis of a second rotational speed of the rotary member.

2. An electronic device comprising:
a rotary member;
a display unit configured to display a selection screen on which a predetermined number of successive selection candidates of a plurality of selection candidates are aligned, and identify and display a predetermined selection target of the predetermined number of selection candidates; and
a display control unit configured to control a transition direction of an identification display target on the basis of a rotational direction of the rotary member, identify and display an immediately succeeding selection candidate or an immediately preceding selection candidate of a predetermined selection candidate on the basis of a first rotational speed of the rotary member, and identify and display an at least second succeeding selection candidate or an at least second preceding selection candidate of the predetermined selection candidate on the basis of a second rotational speed of the rotary member.

3. A device according to claim 2, wherein
the display unit displays the selection screen on which the predetermined number of selection candidates are successively arranged in m rows×n columns, and
the display control unit transits the predetermined number of selection candidates aligned in the selection screen when a selection candidate belonging to a row different from a row to which the predetermined selection candidate belongs is changed to an identification display target upon rotation of the rotary member.

4. A device according to claim 2, wherein
the display unit displays the selection screen on which the predetermined number of selection candidates are successively arranged in m rows×n columns, and
the display control unit controls, on the basis of the rotational speed of the rotary member, a scroll speed of the predetermined number of selection candidates aligned in the selection screen.

5. A device according to claim 2, wherein
the display unit displays the selection screen on which the predetermined number of selection candidates are successively arranged in m rows×n columns, and
the display control unit identifies and displays, on the basis of the second rotational speed of the rotary member, a selection candidate belonging to a row different from a row to which the predetermined selection candidate belongs and belonging to a column which is the same as a column to which the predetermined selection candidate belongs.

6. A device according to claim 2, wherein
the display unit displays the selection screen on which the predetermined number of selection candidates are successively arranged in m rows×n columns, and
the display control unit identifies and displays, on the basis of the second rotational speed of the rotary member, a selection candidate belonging to an Xth row from a row to which the predetermined selection candidate belongs and belonging a column which is the same as a column to which the predetermined selection candidate belongs, and identifies and displays, on the basis of a third rotational speed of the rotary member, a selection candidate belonging to a Yth row from a row to which the predetermined selection candidate belongs and belonging to a column which is the same as a column to which the predetermined selection candidate belongs.

7. A device according to claim 2, wherein the display control unit does not display the identification display target during rotation of the rotary member on the basis of the rotational speed of the rotary member.

8. A device according to claim 2, wherein
the display unit displays the selection screen on which the predetermined number of selection candidates are successively arranged on an arc, and
the display control unit transits the predetermined number of selection candidates aligned in a selection screen when a selection candidate different from the predetermined selection candidate is changed to an identification display target upon rotation of the rotary member.

9. A device according to claim 2, wherein
the display unit displays the selection screen on which the predetermined number of selection candidates are successively arranged on an arc, and
the display control unit controls a scroll speed of the predetermined number of selection candidates aligned in the selection screen on the basis of the rotational speed of the rotary member.

10. A device according to claim 2, wherein
the display unit displays the selection screen on which the predetermined number of selection candidates are successively arranged on an arc, and
the display control unit excludes a selection candidate displayed at one end of the arc from display targets upon rotation of the rotary member, and additionally displays a new selection candidate as the display target at the other end of the arc.

11. A digital camera comprising:
a rotary member;
a photoelectric conversion unit configured to convert an optical image into an electrical signal;
a recording unit configured to record an image on the basis of the electrical signal converted by the photoelectric conversion unit; and
a focus distance control unit configured to control a changeable range of a focus distance between a focus adjustment lens and the photoelectric conversion unit on the basis of an object distance and a rotational speed of the rotary member.

12. A camera according to claim 11, wherein the focus distance control unit controls the focus distance in a first changeable range on the basis of a first object distance and a predetermined rotational speed of the rotary member, and controls the focus distance in a second changeable range which is wider than the first changeable range on the basis of a second object distance which is smaller than the first object distance and the predetermined rotational speed.

13. A camera according to claim 11, wherein the focus distance control unit controls the focus distance in a first changeable range on the basis of a predetermined object distance and a first rotational speed of the rotary member, and controls the focus distance in a second changeable range which is wider than the first changeable range on the basis of the predetermined object distance and a second rotational speed which is higher than the first rotational speed.

14. A camera according to claim 11, wherein the focus distance control unit determines a defined number of steps from the detected object distance on the basis of a relationship between the object distance and a defined number of steps, the relationship representing an increase in the defined number of steps along with a decrease in the object distance, determines an actual number of steps from the detected rotational speed on the basis of a relationship between the rotational speed and the defined number of steps, the relationship representing an increase in the defined number of steps along with an increase in the rotational speed of the rotary member, and controls the focus distance on the basis of the actual number of steps.

15. A camera according to claim 11, wherein the focus distance control unit determines the predetermined number of steps from the detected object distance on the basis of a relationship between the object distance and a defined number of steps, the relationship representing an increase in the defined number of steps along with a decrease in the object distance, sets the predetermined number of steps in accordance with a first rotational speed of the rotary member, sets the defined number of steps in accordance with a second rotational speed which is higher than the first rotational speed of the rotary member, sets the predetermined multiple of the defined number of steps in accordance with a third rotational speed which is higher than the second rotational speed of the rotary member, and controls the focus distance on the basis of the set number of steps.
